(19) United States
(12) Patent Application Publication
(10) Pub. No.: US 2020/0184429 A1
(43) Pub. Date: Jun. 11, 2020

(54) Item Recognition and Profile Generation for Dynamic Event Processing

(71) Applicant: Bank of America Corporation, Charlotte, NC (US)

(72) Inventors: Jeanne M. Moulton, Concord, NC (US); Jasher David Fowles, Davidson, NC (US); Murali Santhanam, Naperville, IL (US); Michael Joseph Pepe, Wilmington, DE (US); John Barrett Hall, Charlotte, NC (US); Kerry Kurt Simpkins, Fort Mill, SC (US); Robert E. Mills, Jr., Stockbridge, GA (US)

(21) Appl. No.: 16/211,341

(22) Filed: Dec. 6, 2018

(51) Int. Cl. G06Q 20/04; G06K 9/46

(52) U.S. Cl. CPC G06Q 20/042; G06K 2209/01; G06K 9/46

(57) ABSTRACT

Aspects of the disclosure relate to processing systems that perform item recognition and profile generation for dynamic event processing. A computing platform may receive a first check image containing first check data, and may generate a profile correlating the first check data to a user account. The computing platform may receive a second check image containing second check data. The computing platform may receive profile information corresponding to one or more recognized fields of the second check image, where the profile information includes the information associated with the profile. The computing platform may determine whether a confidence score indicating a correlation between the second check data and the profile exceeds a predetermined correlation threshold. Based on determining that the confidence score does exceed the predetermined correlation threshold, the computing platform may send commands directing an event processing platform to process the second check image based on the profile.

### BACKGROUND

Aspects of the disclosure relate to enhanced processing systems for processing digital check images. In particular, one or more aspects of the disclosure relate to computing platforms that perform item recognition and profile generation for dynamic event processing.

Many organizations and individuals rely on digital checks as a means for conducting transactions and transferring funds. In many instances, however, conventional digital check processing systems may rely on static profiles and other fixed data sources to identify and correct damaged and/or partially unreadable checks.

### SUMMARY

Aspects of the disclosure provide effective, efficient, scalable, and convenient technical solutions that address and overcome the technical problems associated with the processing of digital checks. For example, some aspects of the disclosure provide techniques that may enable computing platforms to perform item recognition and profile generation for dynamic event processing. By using dynamically created, machine learned profiles for check images that may address and overcome deficiencies of conventional digital check processing technologies that rely on static profiles and/or fixed data sources to identify the check images.

In accordance with an embodiment of the disclosure, a computing platform comprising at least one processor, a communication interface, and memory storing computer-readable instructions may receive a first check image containing first check data. The computing platform may generate a profile correlating the first check data to a user account. The computing platform may receive a second check image containing second check data, where one or more recognized fields of the second check image contain a portion of the first check data and where the second check image includes an unreadable field. The computing platform may receive profile information corresponding to the one or more recognized fields of the second check image, where the profile information includes information associated with the profile. The computing platform may determine whether a confidence score indicating a correlation between the second check data and the profile exceeds a predetermined correlation threshold. Based on determining that the confidence score indicating the correlation between the second check data and the profile does exceed the predetermined correlation threshold, the computing platform may send one or more commands directing an event processing platform to process the second check image based on the profile.

In one or more instances, based on determining that the confidence score indicating the correlation between the second check data and the profile does not exceed the predetermined correlation threshold, the computing platform may send one or more commands directing an error management platform to display an interface indicating that a manual review should be performed.

In one or more instances, the computing platform may receive exception resolution information. The computing platform may adjust the predetermined correlation threshold based on the exception resolution information.

In one or more instances, the exception resolution information may indicate that the profile corresponds to the second check data, and adjusting the predetermined correlation threshold based on the exception resolution information may comprise decreasing the predetermined correlation threshold. In one or more instances, the exception resolution information may indicate that the profile does not correspond to the second check data, and adjusting the predetermined correlation threshold based on the exception resolution information may comprise increasing the predetermined correlation threshold.

In one or more instances, the computing platform may determine the first check data and the second check data using optical character recognition (OCR). In one or more instances, the unreadable field may be a magnetic ink character recognition (MICR) line of the second check image.

In one or more instances, the profile information may correspond to one or more profiles including the profile. In one or more instances, the computing platform may determine that the confidence score indicating the correlation between the second check data and the profile is higher than confidence scores corresponding to the other one or more profiles. Based on the determination that the confidence score indicating the correlation between the second check data and the profile is higher than the confidence scores corresponding to the other one or more profiles, the computing platform may select the profile. In one or more instances, the predetermined correlation threshold may be user specific.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for deploying an enhanced processing system that performs item recognition and profile generation for dynamic event processing in accordance with one or more example embodiments;

FIGS. 2A-2F depict an illustrative event sequence for deploying an enhanced processing system that performs item recognition and profile generation for dynamic event processing in accordance with one or more example embodiments;

FIGS. 3 and 4 depict example graphical user interfaces for deploying an enhanced processing system that performs item recognition and profile generation for dynamic event processing in accordance with one or more example embodiments; and

FIG. 5 depicts an illustrative method for deploying an enhanced processing system that performs item recognition and profile generation for dynamic event processing in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

One or more aspects of the disclosure relate to capturing and storing payer (sometimes also referred to as “payor”) details for checks to be processed. In one or more instances, the check data may be stored using images that may produce high confidence results. This may provide a relationship between routing/account information and the payer (e.g., the customer writing the check). An artificial intelligence (AI) solution may be used to solve for a large portion of the payments or deposits that are flagged as “account not found (ANF).” In some instances, ANF issues may be caused because one digit of a routing/account number on a check may be misread. If this subset of images is sent to an ANF AI service, the ANF issues may be corrected using optical character recognition (OCR), stored data, and AI.

As checks are processed and data is lifted for processing (including the payer data like name, address, city, state, phone, and ZIP code), the data may be stored as an attribute of an account. For example, a name and email address displayed on a check may be identifiers for the account. When accounts cannot be validated, the check images may be sent to an ANF service which first uses OCR to re-read the MICR along with payer data on the check. This data may be compared to the data stored for accounts, routing numbers, and the payer. AI may be used, based on reads determined to be confident, in an attempt to match up the known segments like payer name and address information to resolve misreads caused by bad images, folds, and signature intrusion.

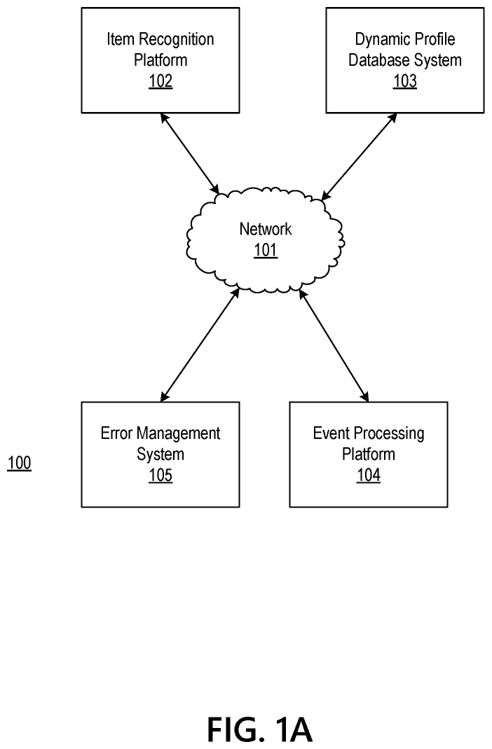

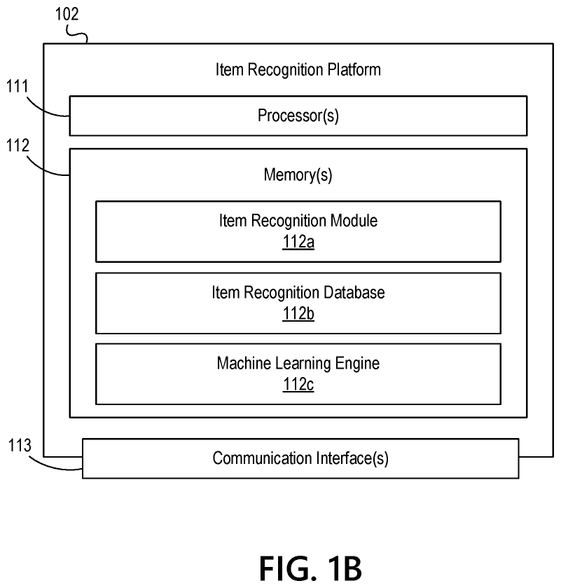

FIGS. 1A-1B depict an illustrative computing environment for deploying an enhanced processing system that performs item recognition and profile generation for dynamic event processing in accordance with one or more example embodiments. Referring to FIG. 1A, computing environment 100 may include one or more computer systems. For example, computing environment 100 may include an item recognition platform 102, a dynamic profile database system 103, an event processing platform 104, and an error management system 105.

As illustrated in greater detail below, item recognition platform 102 may be a computer system that includes one or more computing devices and/or other computer components (e.g., processors, memories, communication interfaces). In addition, item recognition platform 102 may be configured to receive check images, perform OCR on the check images to determine check data, and/or perform one or more other functions. In one or more instances, the item recognition platform 102 may also generate profiles based on the check data, and may compare subsequent check data to the profiles to determine missing information. In these instances, once the missing information is determined, the item recognition platform 102 may generate one or more commands directing an event processing platform 104 and/or an error management system 105 to process a check image based on the missing information.

In one or more instances, item recognition platform 102 may also be configured to generate, host, transmit, and/or otherwise provide graphical user interface information (which may, e.g., cause one or more other computer systems to display and/or otherwise present one or more other graphical user interfaces). In some instances, the graphical user interface information generated by item recognition platform 102 may be used to generate online banking interfaces (e.g., check deposit interfaces, exception management interfaces, or the like) at one or more other computing devices.

Dynamic profile database system 103 may be a computer system that includes one or more computing devices (e.g., servers, server blades, or the like) and/or other computer components (e.g., processors, memories, communication interfaces) that may be used to store the profiles generated by the item recognition platform 102. In one or more instances, the dynamic profile database system 103 may store, host, and/or otherwise provide an internal database associated with an institution (e.g., a financial institution). In one or more instances, the dynamic profile database system 103 may be integrated into the item recognition platform 102. In other instances, the dynamic profile database system 103 might not be integrated into the item recognition platform 102.

Event processing platform 104 may be a computer system that includes one or more computing devices (e.g., desktop computers, laptop computers, tablet computers, servers, server blades, or the like) and/or other computer components (e.g., processors, memories, communication interfaces) configured to receive event processing commands and process events (e.g., check payments, or the like) accordingly. In processing the events, the event processing platform 104 may be configured to transfer funds to and/or from one or more financial accounts maintained by a financial institution operating the event processing platform 104 based on a check image received at the item recognition platform 102.

Error management system 105 may include one or more computing devices and/or other computer components (e.g., processors, memories, communication interfaces). Error management system 105 may cause display of and/or otherwise present one or more graphical user interfaces. In some instances, the error management system 105 may be desktop computer, a laptop computer, a tablet, a mobile device, or the like. In some instances, the graphical user interfaces presented by error management system 105 may be error management interfaces. Such graphical user interfaces, for instance, may provide an employee of an organization, such as an employee of a financial institution, with an opportunity to manually review check images and to cause the corresponding checks to be processed based on the manual review.

Computing environment 100 also may include one or more networks, which may interconnect item recognition platform 102, dynamic profile database system 103, and event processing platform 104. For example, computing environment 100 may include a network 101 (which may interconnect, e.g., item recognition platform 102, dynamic profile database system 103, event processing platform 104, and error management system 105).

In one or more arrangements, item recognition platform 102, dynamic profile database system 103, event processing platform 104, and error management system 105 may be any type of computing device capable of receiving a user interface, receiving input via the user interface, and communicating the received input to one or more other computing devices. For example, item recognition platform 102, dynamic profile database system 103, event processing platform 104, error management system 105, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of item recognition platform 102, dynamic profile database system 103, event processing platform 104, and error management system 105 may, in some instances, be special-purpose computing devices configured to perform specific functions.

Referring to FIG. 1B, item recognition platform 102 may include one or more processors 111, memory 112, and communication interface 113. A data bus may interconnect processor 111, memory 112, and communication interface 113. Communication interface 113 may be a network interface configured to support communication between item recognition platform 102 and one or more networks (e.g., network 101, or the like). Memory 112 may include one or more program modules having instructions that when executed by processor 111 cause item recognition platform 102 to perform one or more functions described herein and/or one or more databases that may store and/or otherwise maintain information which may be used by such program modules and/or processor 111. In some instances, the one or more program modules and/or databases may be stored by and/or maintained in different memory units of item recognition platform 102 and/or by different computing devices that may form and/or otherwise make up item recognition platform 102. For example, memory 112 may have, host, store, and/or include an item recognition module 112a, an item recognition database 112b, and a machine learning engine 112c. Item recognition module 112a may have instructions that direct and/or cause item recognition platform 102 to execute advanced item recognition and profile analysis techniques, as discussed in greater detail below. Item recognition database 112b may store information used by item recognition module 112a and/or item recognition platform 102 in executing item recognition and profile analysis techniques and/or in performing other functions. In one or more instances, in executing the item recognition and profile analysis techniques, the item recognition platform 102 may generate profiles based on check data and may compare future check data to the profiles to determine a result for one or more unreadable fields in the future check data. Machine learning engine 112c may have instructions that direct and/or cause the item recognition platform 102 to perform event management and to set, define, and/or iteratively refine optimization rules and/or other parameters used by the item recognition platform 102 and/or other systems in computing environment 100.

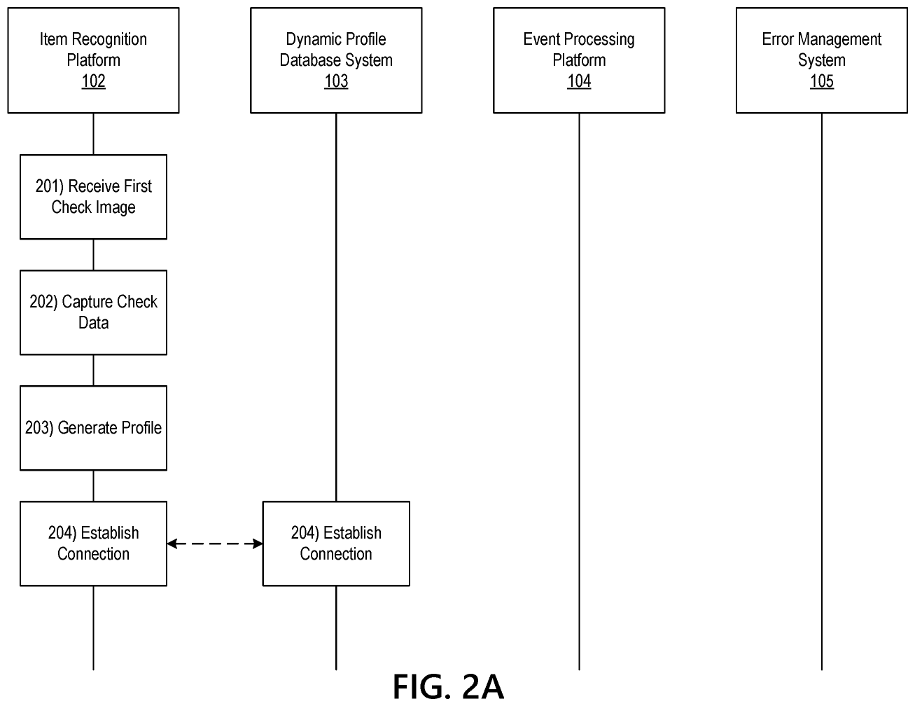

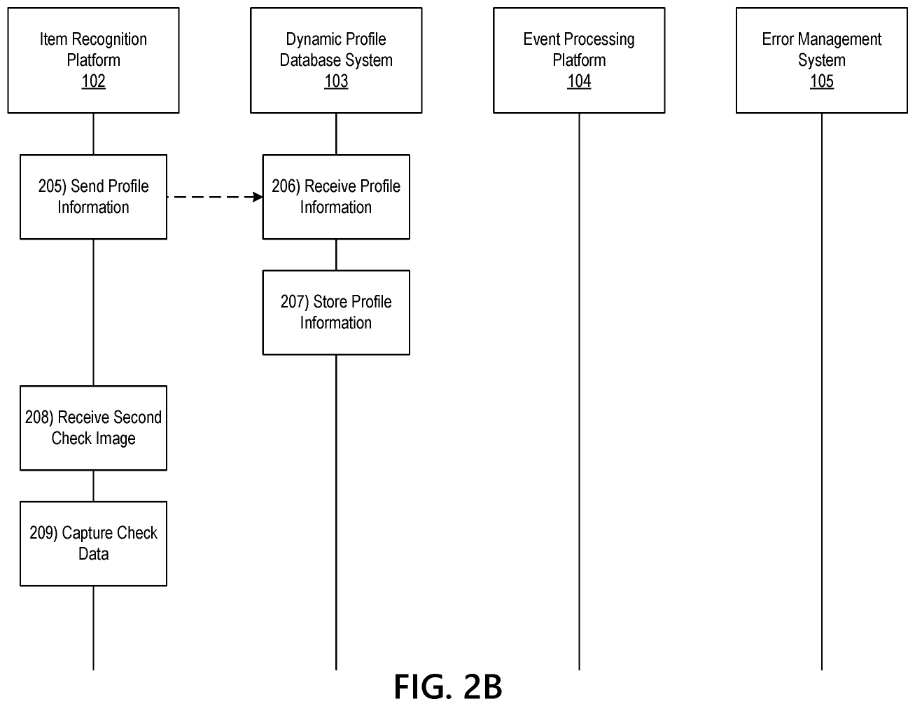

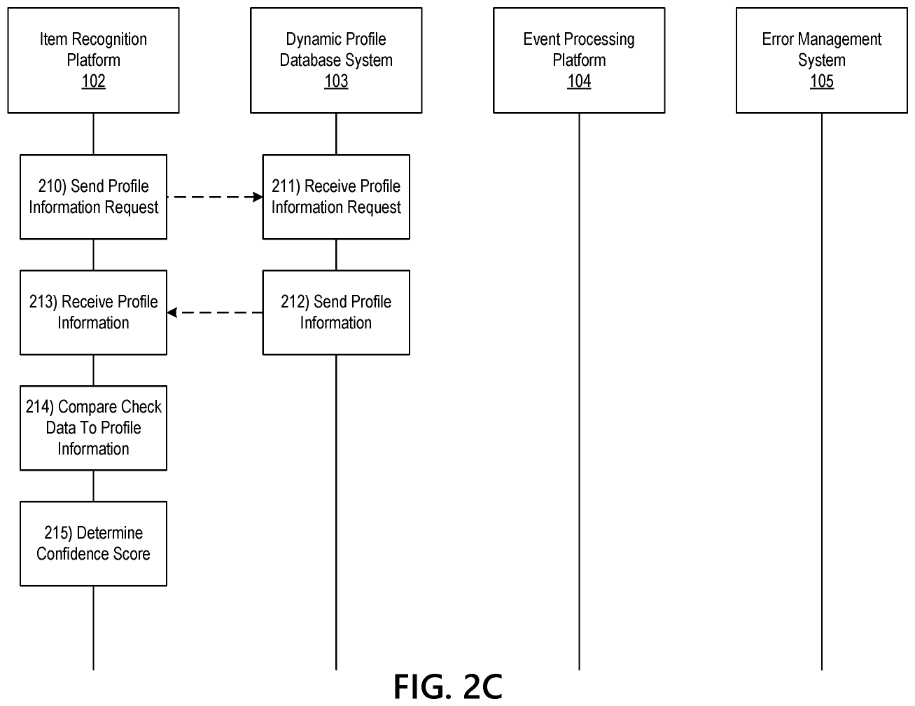

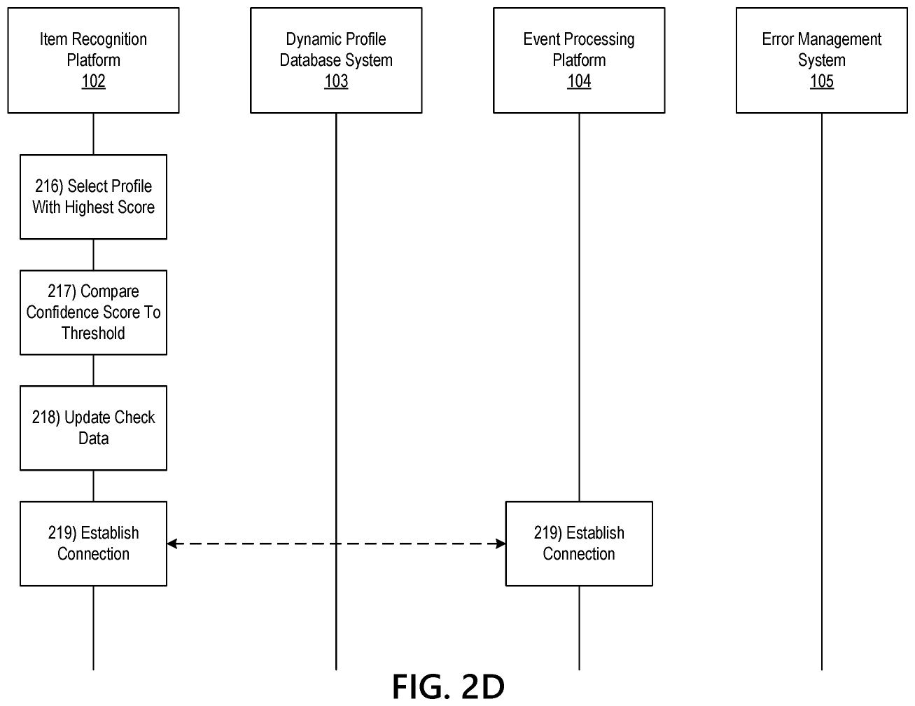

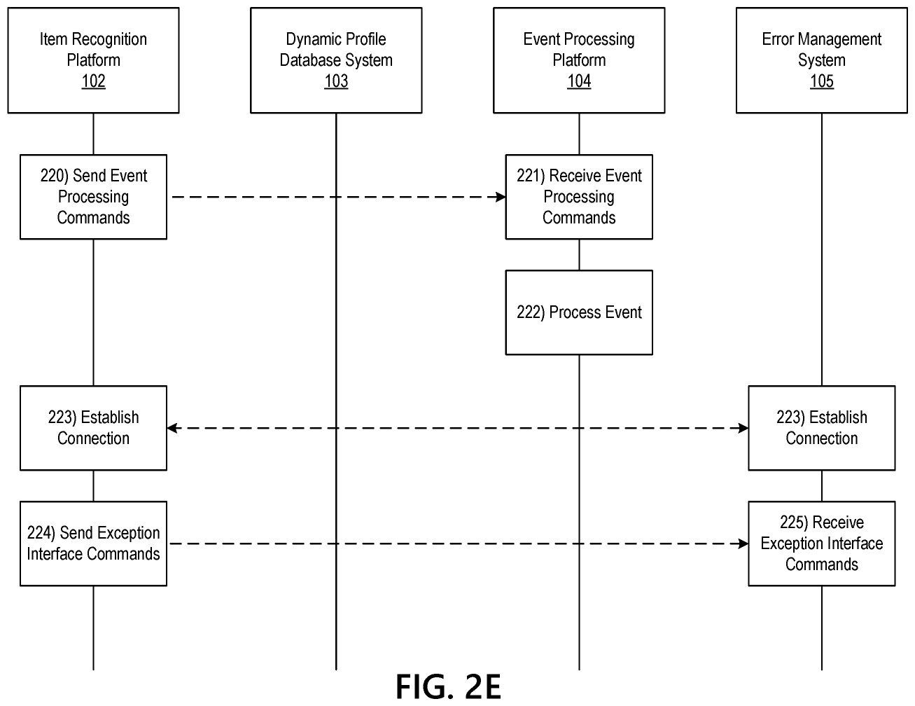

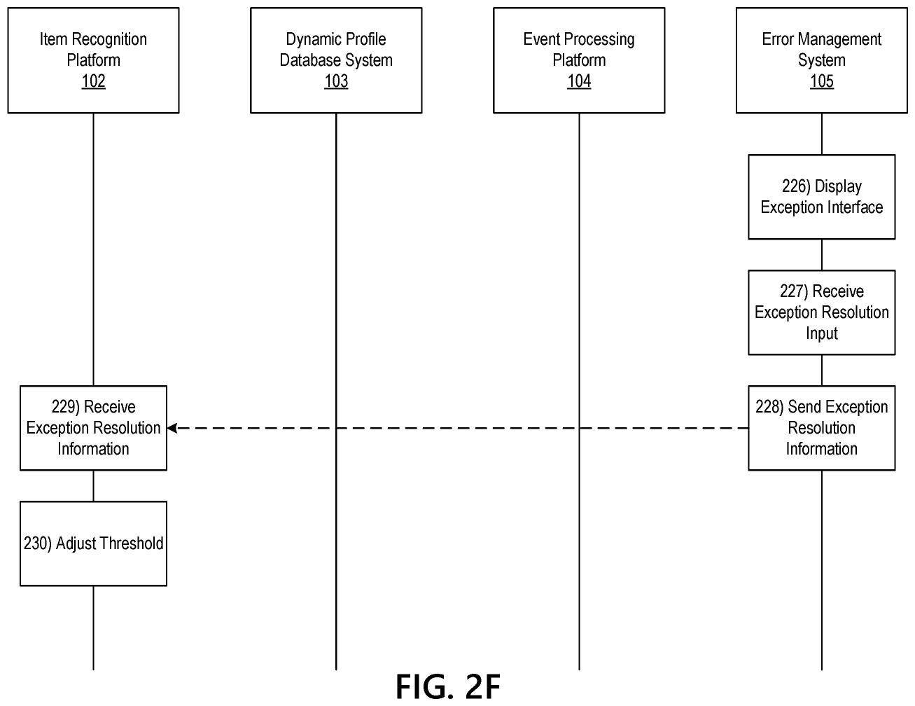

FIGS. 2A-2F depict an illustrative event sequence for deploying an enhanced processing system that performs item recognition and profile generation for dynamic event processing in accordance with one or more example embodiments. Referring to FIG. 2A, at step 201, the item recognition platform 102 may receive a first check image. In one or more instances, in receiving the first check image the item recognition platform 102 may receive a first check image containing a plurality of visible fields (e.g., payee, payor, amount, check background, account number, routing number, address, email, city, state, phone number, ZIP code, driver's license number, or the like). In one or more instances, the item recognition platform 102 may receive the first check image via the communication interface 113.

At step 202, the item recognition platform 102 may capture check data corresponding to the first check. In one or more instances, in capturing the check data corresponding to the first check image, the item recognition platform 102 may perform optical character recognition (OCR) to read text corresponding to the one or more visible fields. In some instances, in reading the text corresponding to the one or more visible fields, the item recognition platform 102 may determine that each visible field is recognizable (e.g., the item recognition platform 102 may be able to read the entire check). In other instances, in reading the text corresponding to the one or more visible fields, the item recognition platform 102 may determine that some visible fields are recognizable, whereas other visible fields are unrecognizable (e.g., the item recognition platform 102 might not be able to read certain fields of the check). In these instances, however, in reading the text corresponding to the one or more visible fields, the item recognition platform 102 may determine that at least a magnetic ink character recognition (MICR) line and one additional field are recognizable. In reading the text, the item recognition platform 102 may determine values for the plurality of visible fields (e.g., payee, payor, amount, check background, account number, routing number, address, email, city, state, phone number, ZIP code, driver's license number, or the like).

At step 203, the item recognition platform 102 may generate a dynamic check profile corresponding to the first check image. In generating the dynamic check profile corresponding to the first check image, the item recognition platform 102 may generate data identifying a correlation between the check data corresponding to the first check image (e.g., the recognizable fields of the first check) and a user account (e.g., the user account indicated by the MICR line of the first check, which may, e.g., correspond to a financial account maintained by a financial institution operating the item recognition platform 102). For example, the dynamic check profile may indicate that checks from a specific payor/email-address/check-background-image combination determined from the first check image should be withdrawn from an account corresponding to the MICR line of the first check image.

At step 204, the item recognition platform 102 may establish a connection with the dynamic profile database system 103. In one or more instances, the item recognition platform 102 may establish a first wireless data connection with the dynamic profile database system 103 to link the item recognition platform 102 to the dynamic profile database system 103.

Referring to FIG. 2B, at step 205, the item recognition platform 102 may send profile information corresponding to the dynamic check profile to the dynamic profile database system 103. In one or more instances, in sending the profile information, the item recognition platform 102 may send the data identifying the correlation between the check data corresponding to the first check and a user account corresponding to the first check. For example, the item recognition platform 102 may send the data identifying the correlation between a payor/email-address/check-background-image combination indicated by the first check image and the account corresponding to the MICR line of the first check image. In one or more instances, the item recognition platform may send the profile information to the dynamic profile database system 103 via the communication interface 113 and while the first wireless data connection is established.

At step 206, the dynamic profile database system 103 may receive the profile information sent at step 205. In one or more instances, the dynamic profile database system 103 may receive the profile information while the first wireless data connection is still established.

At step 207, the dynamic profile database may store the profile information received at step 206. For example, the dynamic profile database system 103 may maintain a list of user accounts and their corresponding check data (e.g., payee, payor, amount, check background, account number, routing number, address, email, city, state, phone number, ZIP code, driver's license number, or the like). In one or more instances, as various check images are received, the dynamic profile database system 103 may continuously update based on check data corresponding to these check images. For example, when new check data is received for a particular account (e.g., no email address previously associated for the account), the dynamic profile database may update the profile to include the new check data. Additionally or alternatively, in one or more instances, profile information may be updated based on a determined change in the check data (e.g., the user moved and changed their address, or the like).

At step 208, the item recognition platform 102 may receive a second check image. In receiving the second check image, the item recognition platform 102 may receive a second check image containing a plurality of visible fields. In one or more instances, the item recognition platform 102 may receive the second check image via the communication interface 113.

At step 209, the item recognition platform 102 may capture check data corresponding to the second check image. As described above with regard to step 202, in capturing the check data corresponding to the second check image the item recognition platform 102 may perform one or more OCR operations on the check image to read the plurality of visible fields on the second check. In one or more instances, the item recognition platform 102 may determine that one or more of the visible fields on the second check are unrecognizable. For example, an account or routing number of the MICR line of the second check image may be partially covered by a payee signature and might not be recognizable. Additionally or alternatively, the item recognition platform 102 may determine that the OCR yielded a bad read of the second check image, leaving the one or more visible fields unrecognizable. Additionally or alternatively, the item recognition platform 102 may determine that the second check image has a poor image quality (e.g., a mobile deposit was made and the resulting check image has poor quality), leaving the one or more visible fields unrecognizable. Additionally or alternatively, the item recognition platform 102 may determine that the second check consists of tears, folds, holes, or the like, which may have resulted in one or more unrecognizable fields for the second digital check image. In these instances, however, the item recognition platform 102 may determine that one or more of the visible fields on the second check are recognizable (e.g., the payor name, email, address, city, state, phone number, ZIP code, driver's license number, or the like). In one or more instances, at least a portion of the check data corresponding to the second check image may correspond to at least a portion of the check data corresponding to the first check image (e.g., matching payee, payor, amount, check background, account number, routing number, address, email, city, state, phone number, ZIP code, driver's license number, or the like).

Referring to FIG. 2C, at step 210, the item recognition platform 102 may generate and send a request for profile information from the dynamic profile database system 103. In one or more instances, the item recognition platform 102 may send the check data corresponding to the second check image along with the request for profile information. In sending the request for the profile information, the item recognition platform 102 may send a request for one or more profiles, similar to the dynamic check profile generated at step 203, that match the check data corresponding to the second check image. In one or more instances, the item recognition platform 102 may send the request for profile information to the dynamic profile database system 103 via the communication interface 113 and while the first wireless data connection is established.

At step 211, the dynamic profile database system 103 may receive the request for profile information from the item recognition platform 102. In one or more instances, the dynamic profile database system 103 may receive the request for profile information while the first wireless data connection is established.

At step 212, the dynamic profile database system 103 may determine profile information that matches the check data corresponding to the second check image and may send the profile information to the item recognition platform 102. In one or more instances, in determining the profile information that matches the check data corresponding to the second check image, the dynamic profile database system 103 may use one or more artificial intelligence algorithms and/or APIs to determine information corresponding to one or more dynamic check profiles, including the dynamic check profile generated at step 203. For example, at least a portion of the check data corresponding to the first check image may match at least a portion of the check data corresponding to the second check image. In one or more instances, the dynamic profile database system 103 may send the profile information to the item recognition platform 102 while the first wireless data connection is established. As an example, the dynamic profile database system 103 may determine a dynamic check profile that matches an address included in the check data corresponding to the second check image, and may send profile information corresponding to that profile.

At step 213, the item recognition platform 102 may receive the profile information sent at step 212. In one or more instances, the item recognition platform 102 may receive the profile information via the communication interface 113 and while the first wireless data connection is established.

At step 214, the item recognition platform 102 may compare the check data corresponding to the second check image with the profile information received at step 213. In one or more instances, in comparing the check data corresponding to the second check image with the profile information, the item recognition platform 102 may recognize and/or otherwise determine a correlation between the two. In recognizing and/or otherwise determining the correlation, the item recognition platform 102 may determine, for example, a number of visible fields containing matching check data, an amount of visible fields that may be compared (e.g., a number of visible fields that have stored profile values), a number of unreadable aspects of the second check image, or the like. In doing so, the item recognition platform 102 may determine a likelihood, for each dynamic check profile included in the profile information, that there is a match between the dynamic check profile and the check data corresponding to the second check image.

At step 215, the item recognition platform 102 may determine, based on the likelihood of a match between the various dynamic check profiles and the check data corresponding to the second check image, a confidence score corresponding to each of the various dynamic check profiles. In one or more instances, in determining the confidence score, the item recognition platform 102 may determine a value between 0 and 100 with 0 being the least likely that there is a match and 100 being the most likely that there is a match.

Referring to FIG. 2D, at step 216, the item recognition platform 102 may select the dynamic check profile that corresponds to the highest confidence score. In one or more instances, in selecting the dynamic check profile that corresponds to the highest confidence score, the item recognition platform 102 may select the dynamic check profile that was generated at step 203.

At step 217, the item recognition platform 102 may compare the confidence score, of the dynamic check profile selected at step 216, to a predetermined correlation threshold. In comparing the confidence score to the predetermined correlation threshold, the item recognition platform 102 may compare the confidence score to a minimum event processing threshold (e.g., a minimum confidence score for the item recognition platform 102 to cause a payment indicated by the second check image to an account indicated in the selected dynamic check profile). For example, the item recognition platform 102 may determine that the payment indicated by the second check image should be caused if the confidence score exceeds 70, otherwise the second check image should be flagged for manual review. In one or more instances, the item recognition platform 102 may determine the predetermined correlation threshold based on a payor associated with the second check image. For example, payors may have different thresholds based on outcomes of previously processed check images. In one or more instances, the item recognition platform 102 may determine that the confidence score does not exceed the predetermined correlation threshold. In these instances, the event sequence may proceed to step 223. In other instances, the item recognition platform 102 may determine that the confidence score exceeds the predetermined correlation threshold. In these instances, the event sequence may proceed to step 218.

At step 218, based on the determination that the confidence score of the selected dynamic check profile exceeds the predetermined correlation threshold at step 218, the item recognition platform 102 may update the second check data stored in memory. For example, if the second check image contained an unrecognizable account number, the item recognition platform 102 may update the second check data to include the account number from the selected dynamic check profile.

At step 219, the item recognition platform 102 may establish a connection with the event processing platform 104. In one or more instances, the item recognition platform 102 may establish a second wireless data connection with the event processing platform 104 to link the item recognition platform 102 to the event processing platform 104.

Referring to FIG. 2E, at step 220, the item recognition platform 102 may generate and send one or more commands directing the event processing platform 104 to process a payment corresponding to the second check image. In one or more instances, the item recognition platform 102 may send the one or more commands directing the event processing platform 104 to process the payment corresponding to the second check image via the communication interface 113 and while the second wireless data connection is established. In one or more instances, in addition to directing the event processing platform 104 to process the payment corresponding to the second check image, the item recognition platform 102 may send one or more commands directing the dynamic profile database system 103 to update the selected dynamic check profile using the check data corresponding to the second check image. For example, if the check data corresponding to the second check image contained an email address, and the selected dynamic check profile did not contain an email address, the item recognition platform 102 may direct the dynamic profile database to include the email address in the selected dynamic check profile. As another example, if the check data corresponding to the second check image contained an address different than the address included in the selected dynamic check profile, the item recognition platform 102 may determine that the user may have moved, and may direct the dynamic profile database to update the addressed included in the selected dynamic check profile accordingly. Accordingly, the dynamic profile database system 103 may update the selected dynamic check profile, resulting in a more comprehensive profile.

At step 221, the event processing platform 104 may receive the one or more commands directing the event processing platform 104 to process the payment corresponding to the second check image. In one or more instances, the event processing platform 104 may receive the one or more commands directing the event processing platform 104 to process the payment corresponding to the second check image while the second wireless data connection is established.

At step 222, the event processing platform 104 may process the payment corresponding to the second check image. For example, the event processing platform 104 may cause a transfer of funds (in an amount indicated by the second check image) from an account of the payor to an account of the payee. The event processing platform 104 may also cause an update to the payor/payee accounts accordingly (e.g., one or more online banking interfaces may be updated to reflect the transfer).

Referring back to step 218, if the item recognition platform 102 determines that the confidence score of the selected dynamic check profile does not exceed the predetermined correlation threshold, at step 223, the item recognition platform 102 may establish a connection with the error management system 105. In one or more instances, the item recognition platform 102 may establish a third wireless data connection with the error management system 105 to link the item recognition platform 102 to the error management system 105.

At step 224, the item recognition platform 102 may generate and send one or more commands directing the error management system 105 to generate an exception management interface. In one or more instances, the item recognition platform 102 may send the one or more commands directing the error management system 105 to generate the exception management interface via the communication interface 113 and while the third wireless data connection is established.

At step 225, the error management system 105 may receive the one or more commands directing the error management system 105 to generate the exception management interface. In one or more instances, the error management system 105 may receive the one or more commands directing the error management system 105 to generate the exception management interface while the third wireless data connection is established.

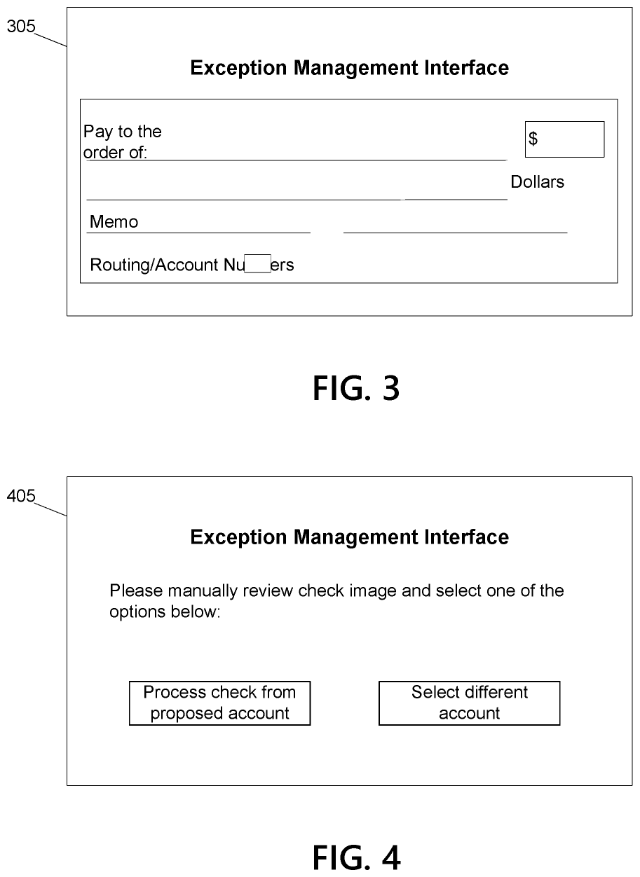

Referring to FIG. 2F, at step 226, the error management system 105 may generate and display an exception management interface. In one or more instances, in displaying the exception management interface, the error management system 105 may display a graphical user interface similar to graphical user interface 305, which is shown in FIG. 3. For example, graphical user interface 305 may include the second check image. Although the second check image in graphical user interface 305 is blank, it should be understood that the various fields of the second check image may be populated. As shown, there may be obstruction to the routing/account numbers in the MICR line. Accordingly, by displaying the graphical user interface 305, the error management system 105 may allow an employee of a financial institution to manually review the second check image, manually compare the second check image to stored profile information, and determine a proper routing/account number for the second check image.

Additionally or alternatively, in displaying the exception management interface, the error management system 105 may generate and display an exception management interface similar to graphical user interface 405, which is shown in FIG. 4. For example, graphical user interface 405 may include an indication that the second check image should be manually reviewed. In one or more instances, the graphical user interface 405 may include a proposed account number, and may prompt the employee to either verify that the proposed account number is correct or propose a different account. In one or more instances, an employee may navigate from the graphical user interface 405 to the graphical user interface 305 to manually review the second check image, and then may navigate back to the graphical user interface 505 to provide a user input regarding how the second check image should be processed.

At step 227, the error management system 105 may receive an exception resolution input. In one or more instances, in receiving the exception resolution input, the error management system 105 may receive an indication that the proposed account (e.g., the account corresponding to the dynamic check profile selected at step 216) is correct and that the payment corresponding to the second check image should be processed accordingly. In other instances, in receiving the exception resolution input, the error management system 105 may receive an indication that the proposed account is not correct and that the payment corresponding to the second check image should be processed to a different account. In one or more instances, the error management system 105 may receive the exception resolution input by receiving a user input via a display or other component of the error management system 105.

At step 228, the error management system 105 may send exception resolution information, based on the exception resolution input, to the item recognition platform 102. In one or more instances, the error management system 105 may send the exception resolution information to the item recognition platform 102 while the third wireless data connection is established.

At step 229, the item recognition platform 102 may receive the exception resolution information sent at step 228. In one or more instances, the item recognition platform 102 may receive the exception resolution information via the communication interface 113 while the third wireless data connection is established.

At step 230, based on the exception resolution information received at step 229, the item recognition platform 102 may adjust the predetermined correlation threshold described above at step 217. In one or more instances, the item recognition platform 102 may determine, based on the exception resolution information, that the profile selected at step 216 indicated the correct account. In these instances, the item recognition platform 102 may reduce the predetermined correlation threshold. For example, if many check images (e.g., a number of check images that exceeds a change threshold) are being flagged for manual review that are ultimately processed from an account corresponding to the selected profile, the predetermined correlation threshold may be reduced. On the other hand, in one or more instances, the item recognition platform 102 may determine, based on the exception resolution information, that the profile selected at step 216 indicated the wrong account. In these instances, the item recognition platform 102 may increase the predetermined correlation threshold. For example, if many check images (e.g., a number of check images that exceeds the change threshold) are being flagged for manual review and ultimately processed from an account that does not correspond to the selected profile, the predetermined correlation threshold may be increased.

Once the correct account has been identified, the item recognition platform 102 may return to steps 218-222 to process the payment accordingly.

Subsequently, the event sequence may end, and the item recognition platform 102 may continue to facilitate the data recognition, profile generation, profile analysis, and event processing associated with digital check images. By processing checks in this way, the item recognition platform 102 may reduce a number of checks sent to an exception queue for manual review. Furthermore, the item recognition platform 102 may improve the accuracy associated with digital check processing by maintaining an dynamic profile database system 103 that may be continuously update as check images are received and may be used to populate unrecognizable fields of a digital check image.

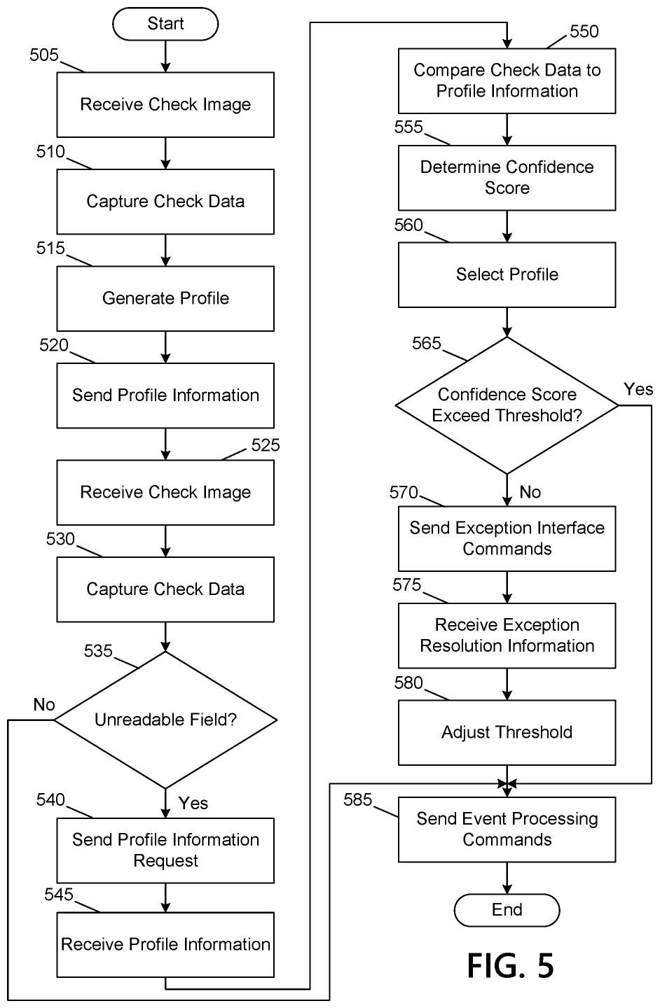

FIG. 5 depicts an illustrative method for deploying an enhanced processing system that performs item recognition and profile generation for dynamic event processing in accordance with one or more example embodiments. Referring to FIG. 5, at step 505, a computing platform having at least one processor, a communication interface, and memory may receive a first check image. At step 510, the computing platform may capture check data corresponding to the first check image. At step 515, the computing platform may generate a dynamic check profile based on the check data corresponding to the first check image. At step 520, the computing platform may send profile information corresponding to the dynamic check profile to a dynamic profile database for storage. At step 525, the computing platform may receive a second check image. At step 530, the computing platform may determine check data corresponding to the second check image. At step 535, the computing platform may determine whether a visible field of the check image is unreadable. If the check image does not contain an unreadable field, the computing platform may proceed to step 585. If the check image does contain an unreadable field, the computing platform may proceed to step 540.

At step 540, the computing platform may send a request to the dynamic profile database for profile information. At step 545, the computing platform may receive profile information from the dynamic profile database. At step 550, the computing platform may compare check data from the second check image to the profile information. At step 555, the computing platform may determine a confidence score for each dynamic check profile associated with the profile information. At step 560, the computing platform may select a dynamic check profile. At step 565, the computing platform may determine whether a confidence score corresponding to the selected profile exceeds a predetermined correlation threshold. If the confidence score does exceed the predetermined correlation threshold, the computing platform may proceed to step 575. If the confidence score does not exceed the predetermined correlation threshold, the computing platform may proceed to step 570.

At step 570, the computing platform may generate and send one or more commands directing an error management system 105 to display an exception management interface. At step 575, the computing platform may receive exception resolution information. At step 580, the computing platform may adjust the predetermined correlation threshold based on the exception resolution information. At step 585, the computing platform may generate and send one or more commands directing an event processing platform to process a payment corresponding to the second check image.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the processor, cause the computing platform to:
receive a first check image containing first check data;
generate a profile correlating the first check data to a user account;
receive a second check image containing second check data, wherein one or more recognized fields of the second check image contain a portion of the first check data and wherein the second check image includes an unreadable field;
receive profile information corresponding to the one or more recognized fields of the second check image, wherein the profile information includes information associated with the profile;
determine whether a confidence score indicating a correlation between the second check data and the profile exceeds a predetermined correlation threshold; and
based on determining that the confidence score indicating the correlation between the second check data and the profile does exceed the predetermined correlation threshold, send one or more commands directing an event processing platform to process the second check image based on the profile.

2. The computing platform of claim 1, wherein the memory stores additional computer-readable instructions that, when executed by the at least one processor, further cause the computing platform to, based on determining that the confidence score indicating the correlation between the second check data and the profile does not exceed the predetermined correlation threshold, send one or more commands directing an error management platform to display an interface indicating that a manual review should be performed.

3. The computing platform of claim 1, wherein the memory stores additional computer-readable instructions that, when executed by the at least one processor, further cause the computing platform to:
receive exception resolution information; and
adjust the predetermined correlation threshold based on the exception resolution information.

4. The computing platform of claim 3, wherein the exception resolution information indicates that the profile corresponds to the second check data, and wherein adjusting the predetermined correlation threshold based on the exception resolution information comprises decreasing the predetermined correlation threshold.

5. The computing platform of claim 3, wherein the exception resolution information indicates that the profile does not correspond to the second check data, and wherein adjusting the predetermined correlation threshold based on the exception resolution information comprises increasing the predetermined correlation threshold.

6. The computing platform of claim 1, wherein the memory stores additional computer-readable instructions that, when executed by the at least one processor, further cause the computing platform to determine the first check data and the second check data using optical character recognition (OCR).

7. The computing platform of claim 1, wherein the unreadable field corresponds to a magnetic ink character recognition (MICR) line of the second check image.

8. The computing platform of claim 1, wherein the profile information corresponds to one or more profiles including the profile.

9. The computing platform of claim 8, wherein the memory stores additional computer-readable instructions that, when executed by the at least one processor, further cause the computing platform to:
determine that the confidence score indicating the correlation between the second check data and the profile is higher than confidence scores corresponding to the other one or more profiles; and
select, based on the determination that the confidence score indicating the correlation between the second check data and the profile is higher than the confidence scores corresponding to the other one or more profiles, the profile.

10. The computing platform of claim 1, wherein the predetermined correlation threshold is user specific.

11. A method comprising:
at a computing platform comprising at least one processor, a communication interface, and memory:
receiving a first check image containing first check data;
generating a profile correlating the first check data to a user account;
receiving a second check image containing second check data, wherein one or more recognized fields of the second check image contain a portion of the first check data and wherein the second check image includes an unreadable field;
receiving profile information corresponding to the one or more recognized fields of the second check image, wherein the profile information includes information associated with the profile;
determining whether a confidence score indicating a correlation between the second check data and the profile exceeds a predetermined correlation threshold; and
based on determining that the confidence score indicating the correlation between the second check data and the profile does exceed the predetermined correlation threshold, sending one or more commands directing an event processing platform to process the second check image based on the profile.

12. The method of claim 11, further comprising:
based on determining that the confidence score indicating the correlation between the second check data and the profile does not exceed the predetermined correlation threshold, sending one or more commands directing an error management platform to display an interface indicating that a manual review should be performed.

13. The method of claim 11, further comprising:
receiving exception resolution information; and
adjusting the predetermined correlation threshold based on the exception resolution information.

14. The method of claim 13, wherein the exception resolution information indicates that the profile corresponds to the second check data, and wherein adjusting the predetermined correlation threshold based on the exception resolution information comprises decreasing the predetermined correlation threshold.

15. The method of claim 13, wherein the exception resolution information indicates that the profile does not correspond to the second check data, and wherein adjusting the predetermined correlation threshold based on the exception resolution information comprises increasing the predetermined correlation threshold.

16. The method of claim 11, further comprising determining the first check data and the second check data using optical character recognition (OCR).

17. The method of claim 11, wherein the unreadable field corresponds to a magnetic ink character recognition (MICR) line of the second check image.

18. The method of claim 11, wherein the profile information corresponds to one or more profiles including the profile.

19. The method of claim 18, further comprising:
determining that the confidence score indicating the correlation between the second check data and the profile is higher than confidence scores corresponding to the other one or more profiles; and
selecting, based on the determination that the confidence score indicating the correlation between the second check data and the profile is higher than the confidence scores corresponding to the other one or more profiles, the profile.

20. One or more non-transitory computer-readable media storing instructions that, when executed by a computing platform comprising at least one processor, a communication interface, and memory, cause the computing platform to:
receive a first check image containing first check data;
generate a profile correlating the first check data to a user account;
receive a second check image containing second check data, wherein one or more recognized fields of the second check image contain a portion of the first check data and wherein the second check image includes an unreadable field;
receive profile information corresponding to the one or more recognized fields of the second check image, wherein the profile information includes information associated with the profile;
determine whether a confidence score indicating a correlation between the second check data and the profile exceeds a predetermined correlation threshold; and
based on determining that the confidence score indicating the correlation between the second check data and the profile does exceed the predetermined correlation threshold, send one or more commands directing an event processing platform to process the second check image based on the profile.
